(19) United States
(12) Patent Application Publication
(10) Pub. No.: US 2015/0033731 A1
(43) Pub. Date: Feb. 5, 2015

(54) BUOYANCY ENGINE

(71) Applicants: Kunji KUROSAWA, Tokyo (JP); Young Song KIM, Gyongnam (KR); Hiruta Corporation, Tokyo (JP)

(72) Inventors: Kunji KUROSAWA, Tokyo (JP); Young Song KIM, Gyongnam (KR)

(73) Assignees: Kunji KUROSAWA, Tokyo (JP); Hiruta Corporation, Tokyo (JP); Young Song KIM, Gyongnam (KR)

(21) Appl. No.: 14/193,978

(22) Filed: Feb. 28, 2014

(30) Foreign Application Priority Data
Jul. 30, 2013 (JP) 2013-157432

(51) Int. Cl. F03B 17/02

(52) U.S. Cl. CPC F03B 17/02
USPC 60/502

(57) ABSTRACT

Provided is a buoyancy engine that generates power by using buoyancy acting on an object inside a liquid such as water. When a part of moving bodies 5 located in a liquid accumulated in an ascending passage P1 ascend by buoyancy, the plurality of moving bodies 5 arranged in series in a circle in a circulation passage move in a circulating manner while being pushed by the moving bodies 5. Since a sealing portion 40 provided at the lower side of the ascending passage P1 seals a gap between the moving body 5 and the inner wall of the circulation passage, the liquid accumulated in the ascending passage P1 does not instantly leak to a lower passage P8. Accordingly, the liquid is continuously accumulated in the ascending passage P1 to a certain degree, and the moving bodies 5 continuously move in a circulating manner in the circulation passage.

### BACKGROUND OF THE INVENTION

1. Field of the Invention

The present invention relates to a power engine that uses buoyancy acting on an object inside a liquid such as water.

2. Description of the Related Art

An internal combustion engine or an external combustion engine of the related art generates power by driving an object using explosion power caused by combustion of fuel, a pressure of a vapor caused by combustion heat, or a pressure of air. Further, a water turbine that is provided in a pumped storage power plant converts the energy of water falling from a high place to a low place into power.

### SUMMARY OF THE INVENTION

In the internal combustion engine or the external combustion engine of the related art that burns fuel, a problem arises in that a gas causing air pollution or global warming is discharged from the engine. Further, the water turbine that is provided in the pumped storage power plant of the related art needs a large-scaled facility and a wide place, and hence a long installation time is needed. As a result, a problem arises in that economic efficiency is low.

The present invention is made in view of such circumstances, and an object thereof is to provide a buoyancy engine that generates power by using buoyancy acting on an object inside a liquid such as water as a power engine that is easily manufactured due to its simple configuration, does not need a wide place or area, and is installed in a short time.

Further, another object of the present invention is to provide a buoyancy engine as a power engine that does not generate a pollution source such as an exhaust gas and has a small burden on natural environment.

According to the present invention, there is provided a buoyancy engine including: a circulation passage forming portion that forms a closed circulation passage including an ascending passage extending in the vertical direction and a return passage returning from an upper end of the ascending passage to a lower end thereof; a plurality of moving bodies that are arranged in series in the circulation passage; a liquid injector that injects a liquid having a specific weight heavier than that of each moving body into the ascending passage; and a sealing portion that seals a gap between an inner wall of the circulation passage forming portion and the moving body located at the lower side of the ascending passage. Then, the liquid injector includes a liquid tank that receives the liquid overflowing from the upper end of the ascending passage and a pump that sends the liquid flowing out of a lower end of the liquid tank to the lower end of the ascending passage while applying a pressure to the liquid. Further, the liquid transported to the lower end of the ascending passage by the pump ascends in the ascending passage, and the moving body is floated in the ascending liquid.

Desirably, the moving body may have a columnar shape in which a convex portion is formed in at least one of two facing flat surfaces. When two upper and lower adjacent moving bodies in the ascending passage contact each other, the convex portion or the flat surface of one moving body may come into contact with the convex portion or the flat surface of the other moving body, and a liquid intrusion allowing gap may be formed between two moving bodies.

Desirably, a plurality of stages of sealing portions may be provided in the inner wall of the circulation passage forming portion at the lower side of the ascending passage.

For example, the sealing portion may include an annular groove portion that is formed in the inner wall of the circulation passage forming portion and an annular elastic member that is fitted to the groove portion.

Desirably, the buoyancy engine may further include a guide member that guides the moving body so that the moving body ascends from the lower end of the ascending passage to the upper end thereof in the vertical direction.

Desirably, the return passage may include a descending passage that extends in the vertical direction, a first curved passage that is provided in at least a part of a passage guiding the moving body from the upper end of the ascending passage to the upper end of the descending passage, and a second curved passage that is provided in at least a part of a passage guiding the moving body from the lower end of the descending passage to the lower end of the ascending passage.

Desirably, the buoyancy engine may further include at least one rotation body that is provided in the inner wall of the circulation passage forming portion forming the first curved passage and/or the second curved passage and rotates while contacting the moving body.

Desirably, the buoyancy engine may further include a rotation body; and a generator that generates electric power in response to the rotation about the axis of the rotation body. Then, the rotation body may rotate while contacting the moving body exposed to the outside through a notched hole formed in a part of the circulation passage forming portion forming the return passage.

According to the present invention, there are effects that the buoyancy engine may be easily manufactured due to its simple configuration, does not need a wide space or area, and may be installed in a short time. Further, according to the present invention, there are effects that a pollution material such as an exhaust gas is not generated and a burden on natural environment is small.

### BRIEF DESCRIPTION OF THE DRAWINGS

FIG. 1 is a diagram illustrating an example of a configuration of a buoyancy engine according to the embodiment, where a moving body moving along a circulation passage in a circulating manner is not illustrated.

FIG. 2 is a diagram illustrating an example of a configuration of the buoyancy engine according to the embodiment, where the moving body moving along the circulation passage in a circulating manner is graphically illustrated.

FIGS. 3A and 3B are diagrams illustrating an example of the moving body.

FIGS. 4A and 4B are diagrams illustrating another example of the moving body.

### DETAILED DESCRIPTION OF THE PREFERRED EMBODIMENTS

Hereinafter, a buoyancy engine according to an embodiment of the present invention will be described with reference to the drawings.

In the buoyancy engine according to the embodiment, a plurality of moving bodies (floaters) are densely arranged in an annular shape in a closed circulation passage. An ascending passage filled with a liquid such as water is formed in a part of the circulation passage. The lower inlet of the ascending passage is provided with a sealing portion that seals a gap between the moving body and the inner wall of the ascending passage. Due to the sealing portion, the liquid charged into the ascending passage does not leak instantly. Since the specific weight of the liquid is heavier than that of the moving body, buoyancy acts on the moving body immersed into the liquid in the ascending passage. Further, the liquid that is pressurized by a pump is transported to the lower end of the ascending passage, and the liquid ascends from the lower end of the ascending passage to the upper end thereof. The liquid that overflows from the upper end of the ascending passage is first stored in a tank, is supplied from the lower end of the tank to an intake port of the pump, and is transported to the lower end of the ascending passage again. The moving body that is immersed into water from the lower inlet of the ascending passage is floated by the buoyancy in the ascending liquid. Since the moving body is floated in the ascending passage, all the moving bodies arranged in the entire circulation passage move in the closed circulation passage in a circulating manner.

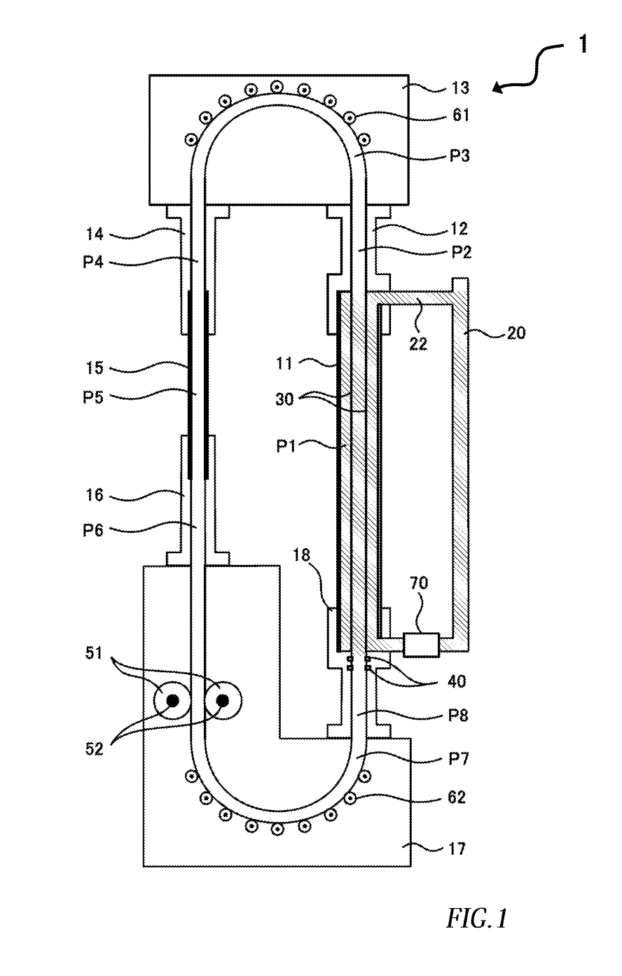

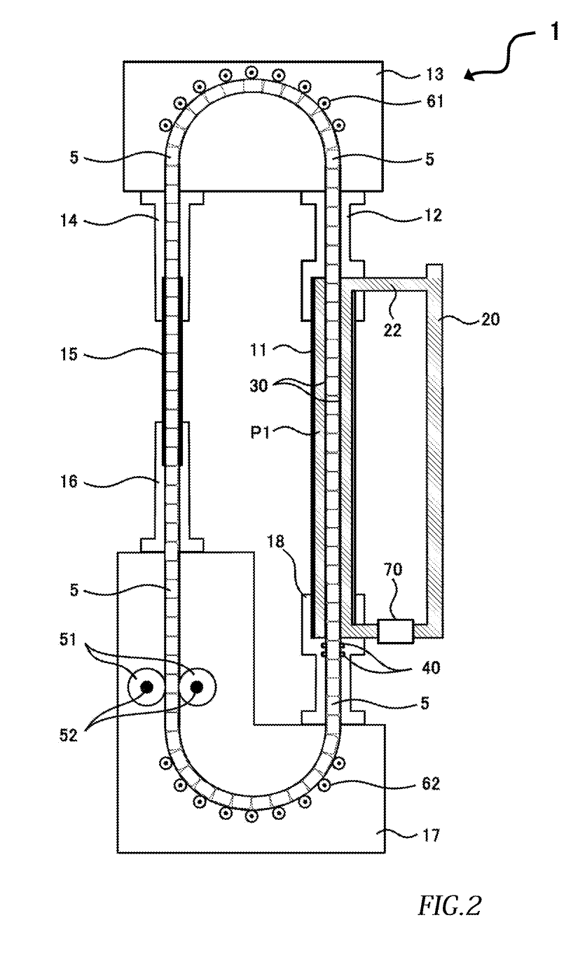

FIGS. 1 and 2 are diagrams illustrating an example of a configuration of a buoyancy engine 1 according to the embodiment. FIG. 1 is a diagram in which a moving body 5 existing in a circulation passage is not illustrated, and FIG. 2 is a diagram in which the moving body 5 existing in the circulation passage is graphically illustrated.

The buoyancy engine 1 illustrated in FIG. 1 includes an ascending passage forming portion 11, a descending passage forming portion 15, a lower circulation passage forming portion 17, an upper circulation passage forming portion 13, and connection portions 12, 14, 16, and 18. These blocks (11 to 18) form a closed circulation passage, and a plurality of the moving bodies 5 are inserted into the circulation passage.

In the closed circulation passage that is formed by the blocks (11 to 18), the plurality of congruent moving bodies 5 are densely arranged in a circle. Each moving body 5 has, for example, a columnar shape and smoothly moves in the circulation passage having a substantially circular cross-section. For example, a hollow portion is formed inside the moving body 5. The specific weight of the moving body 5 is lighter than that of a liquid of a liquid tank 20.

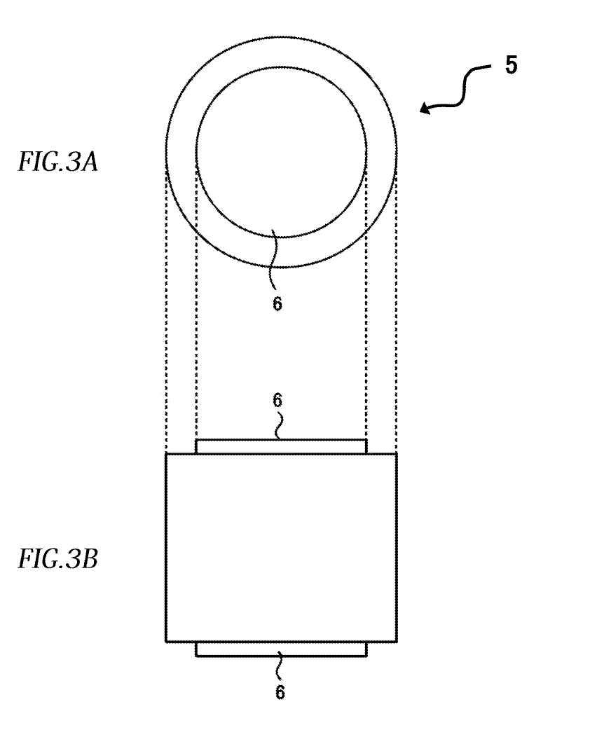

FIGS. 3A and 3B are diagrams illustrating an example of the moving body 5. FIG. 3A is a top view and FIG. 3B is a side view.

Each of two facing flat surfaces of the columnar moving body 5 is provided with a convex portion 6. The convex portion 6 protrudes in a columnar shape from the center portion in the circular flat surface of the moving body 5. In a case where two upper and lower adjacent moving bodies 5 contact each other in an ascending passage P1 formed in the ascending passage forming portion 11, the convex portion 6 of the upper moving body 5 comes into contact with the convex portion 6 of the lower moving body 5, and a liquid intrusion allowing gap is formed between two moving bodies 5. When the liquid intrudes into the gap, buoyancy is generated in the moving body 5, and a force caused by the upward flow of the liquid acts on the moving body 5. The moving body 5 ascends inside the ascending passage P1 due to the action of the buoyancy and the action of the upward flow of the liquid.

The ascending passage forming portion 11 is a member that forms the ascending passage P1 extending upward in the vertical direction, and is formed in, for example, a pipe shape as indicated by FIGS. 1 and 2. The upper end of the ascending passage forming portion 11 is connected to the upper circulation passage forming portion 13 through the connection portion 12, and the lower end of the ascending passage forming portion 11 is connected to the lower circulation passage forming portion 17 through the connection portion 18.

The buoyancy engine 1 according to the embodiment includes a liquid tank 20 and a pump 70 as units (liquid injectors) for injecting a liquid such as water into the ascending passage forming portion 11. The liquid tank 20 is a tank that stores a liquid such as water therein, and has, for example, a cylindrical shape extending in the vertical direction as indicated by FIGS. 1 and 2. The specific weight of the liquid stored in the liquid tank 20 is heavier than that of the moving body 5. The pump 70 sends the liquid flowing out of the lower end of the liquid tank 20 to the lower end of the ascending passage P1 while applying a pressure to the liquid. The liquid that is charged into the ascending passage P1 ascends from the lower end of the ascending passage P1 to the upper end thereof by the pressure of the pump 70. The upper end of the ascending passage P1 is connected to the liquid tank 20 by a connection passage 22. The liquid that flows out of the upper end of the ascending passage P1 flows into the liquid tank 20 through the connection passage 22. Accordingly, the liquid of the liquid tank 20 returns to the liquid tank 20 again through the pump 70, the ascending passage P1, and the connection passage 22.

The buoyancy engine 1 illustrated in FIGS. 1 and 2 includes a guide member 30 that guides the moving body 5 so that the moving body 5 ascends in the vertical direction from the lower end of the ascending passage P1 of the ascending passage forming portion 11 to the upper end thereof. The guide member 30 illustrated in the examples of FIGS. 1 and 2 is formed as a plurality of bars extending in the vertical direction. One end of the bar is fixed to the edge of the lower end of the ascending passage P1, and the other end of the bar is fixed to the edge of the upper end of the ascending passage P1. The moving body 5 that intrudes from a passage P8 of the connection portion 18 to the inlet of the lower end of the ascending passage P1 ascends straightly toward the outlet of the upper end of the ascending passage P1 while being guided by the bar of the guide member 30.

Two sealing portions 40 are provided in the connection portion 18 connected to the lower end of the ascending passage forming portion 11. The sealing portions 40 seal a gap formed between the inner wall of the connection portion 18 and the moving body 5 passing through the connection portion 18. For example, each sealing portion 40 includes an annular groove portion that is formed in the inner wall of the connection portion 18 and an annular elastic member (rubber, silicon, or the like) that is fitted to the groove portion. The moving body 5 passes through the center hole of the annular elastic member while the side surface thereof slides on the inner peripheral surface of the annular elastic member.

When the gap between the moving body 5 and the inner wall of the connection portion 18 is sealed by the sealing portions 40, the liquid that flows from the liquid tank 20 to the ascending passage P1 of the ascending passage forming portion 11 hardly leaks to the passage P8 of the lower connection portion 18. For this reason, as indicated by the diagonal line of FIGS. 1 and 2, the liquid is accumulated in the ascending passage P1 of the ascending passage forming portion 11.

The descending passage forming portion 15 is a member that forms a descending passage P5 extending downward in the vertical direction and is formed in, for example, a pipe shape as indicated by FIGS. 1 and 2. The upper end of the descending passage forming portion 15 is connected to the upper circulation passage forming portion 13 through the connection portion 14, and the lower end of the descending passage forming portion 15 is connected to the lower circulation passage forming portion 17 through the connection portion 16.

The upper circulation passage forming portion 13 forms a passage P3 of the moving body 5 from an upper end of a passage P2 of the connection portion 12 to an upper end of a passage P4 of the connection portion 14. As indicated by FIGS. 1 and 2, the passage P3 includes a semi-circular curved portion (a first curved passage). The movement direction of the moving body 5 is reversed from the upward direction to the downward direction in the first curved passage.

A plurality of rotation bodies 61 that rotate while contacting the moving bodies 5 are disposed in the inner wall of the upper circulation passage forming portion 13 forming the first curved passage. Each rotation body 61 is, for example, a cylindrical body that is supported so as to be rotatable about the axis perpendicular to the extension direction of the first curved passage, and the rotation bodies 61 are disposed along the first curved passage. In the examples illustrated in FIGS. 1 and 2, the rotation bodies 61 are disposed in series at the upper side of the first curved passage. Due to the rotation bodies 61, the friction between the moving body 5 and the inner wall of the upper circulation passage forming portion 13 is reduced.

The lower circulation passage forming portion 17 forms a passage P7 of the moving body 5 from a lower end of a passage P6 of the connection portion 16 to the lower end of the passage P8 of the connection portion 18. As indicated by FIGS. 1 and 2, the passage P7 includes a semi-circular curved portion (a second curved passage). The movement direction of the moving body 5 is reversed from the downward direction to the upward direction in the second curved passage. A discharge port (not illustrated) that discharges the liquid leaking from the sealing portion 40 is provided at the lower side of the passage P7.

A plurality of rotation bodies 62 that rotate while contacting the moving body 5 are disposed in the inner wall of the lower circulation passage forming portion 17 forming the second curved passage. Each rotation body 62 is, for example, a cylindrical body that is supported so as to be rotatable about the axis perpendicular to the extension direction of the second curved passage, and the rotation bodies 62 are disposed along the second curved passage. In the examples illustrated in FIGS. 1 and 2, the rotation bodies 62 are disposed in series at the lower side of the second curved passage. Due to the rotation bodies 62, the friction between the moving body 5 and the inner wall of the lower circulation passage forming portion 17 is reduced.

Further, the buoyancy engine 1 according to the embodiment includes a generator that generates power based on the circulating movement of the moving body 5 in the circulation passage. In the examples of FIGS. 1 and 2, two rotation bodies 51 provided in the course of the passage P7 of the lower circulation passage forming portion 17 form a part of a power transmission mechanism that transmits the power of the moving body 5 to the generator. The lower circulation passage forming portion 17 includes a notched hole from which the moving body 5 passing through the passage P7 is partially exposed to the outside of the passage P7. The rotation bodies 51 rotate while contacting the moving body 5 exposed to the outside through the notched hole. The power that is generated in a rotation shaft 52 of the rotation body 51 is transmitted to the generator through a power transmission mechanism such as a gear or a timing belt, and is converted into electric power.

That is, the moving body 5 falls through the passages P5 and P6 and contacts the rotation body 51 so as to rotate the rotation body 51. At this time, a rotation force generated in the moving body 5 by the gravity is applied to the rotation body 51. In the embodiment, since the plurality of moving bodies 5 are densely arranged in a circle as described above, the rotation force generated in the moving body 5 by the gravity is continuously applied to the rotation body 51. The rotation force applied to the rotation body 51 increases as the weight of the moving body 5 increases.

Here, the operation of the buoyancy engine 1 with the above-described configuration will be described.

When a liquid such as water is poured into the liquid tank 20 of the buoyancy engine 1, the liquid flows into the ascending passage P1 through the communication portion 22. At this time, since the moving body 5 that is located at the connection portion 18 at the lower side of the ascending passage P1 comes into close contact with the sealing portion 40 provided in the connection portion 18, the liquid that flows into the ascending passage P1 is accumulated in the ascending passage P1 without instantly flowing to the passage P8 of the connection portion 18.

When the pump 70 is operated while the liquid is accumulated to the upper end of the ascending passage P1, the liquid is transported from the lower end of the liquid tank 20 to the lower end of the ascending passage P1 while a pressure is applied thereto by the pump 70. Accordingly, the liquid ascends from the lower end of the ascending passage P1 toward the upper end thereof. The liquid that overflows from the upper end of the ascending passage P1 returns to the liquid tank 20 through the connection passage 22.

When the liquid ascends in the ascending passage P1, the moving body 5 inside the liquid receives the raising force caused by buoyancy and the raising force caused by the liquid flow. The moving body 5 that receives the raising force ascends inside the ascending passage P1. Since the plurality of moving bodies 5 are densely arranged in series in the circulation passage, when a part of the moving bodies 5 located at the ascending passage P1 ascend, the other moving bodies 5 located at the downstream side thereof also sequentially move while being pushed by the upstream moving bodies 5. Accordingly, the plurality of moving bodies 5 start to move inside the circulation passage in a circulating manner. In the example of FIG. 2, the plurality of moving bodies 5 move in a circulating manner in a counter-clockwise direction. When the moving body 5 passes through the sealing portion 40, a part of the liquid accumulated in the ascending passage P1 leaks from the gap between the moving body 5 and the sealing portion 40 and flows to the lower passage P8. In order to prevent a problem in which the amount of the liquid of the ascending passage P1 decreases due to the leakage of the liquid and the buoyancy of the moving body 5 decreases, the liquid is frequently supplied to the liquid tank 20. Accordingly, the plurality of moving bodies 5 continuously move in a circulating manner in the circulation passage.

When the moving body 5 moves in a circulating manner inside the circulation passage, the rotation body 51 that is disposed in the lower circulation passage forming portion 17 rotates while contacting the moving body 5. The rotational driving force drives a generator through a power transmission mechanism such as a gear or a timing belt, so that electricity is generated.

As described above, according to the buoyancy engine 1 of the embodiment, the raising force caused by the upward flow of the liquid and the raising force caused by buoyancy act on the moving body 5 located at the ascending passage P1. When the moving body 5 inside the ascending passage P1 ascends while receiving the raising force, the plurality of moving bodies 5 arranged in series in a circle in the circulation passage move in a circulating manner at the same time. Since the sealing portion 40 that is located at the lower side of the ascending passage P1 seals a gap between the moving body 5 and the inner wall of the circulation passage, the liquid that is accumulated in the ascending passage P1 does not instantly leak to the lower passage PB. Accordingly, the liquid is continuously accumulated in the ascending passage P1 to a certain degree, and the moving body 5 continuously moves in a circulating manner in the circulation passage. When the liquid disappears in the ascending passage P1 due to the leakage of the liquid in the sealing portion 40, the raising force acting on the moving body 5 disappears, so that the circulating movement of the moving body 5 stops. However, when the liquid is appropriately supplied from the outside to the liquid tank 20, the moving body 5 may continuously move in a circulating manner. The circulating movement of the moving body 5 is converted into the rotational driving force by the rotation body 51, and is converted into electricity by the generator.

Accordingly, the buoyancy engine 1 of the embodiment has an extremely simple configuration and may convert the movement energy into the electricity in a manner such that the circulating movement of the moving body 5 is continuously performed by the liquid appropriately supplied from the outside.

Further, since the buoyancy engine 1 of the embodiment has an extremely simple configuration, the buoyancy engine 1 may be installed in a short time. Moreover, since the buoyancy engine 1 does not need a wide space or area, the buoyancy engine 1 may be also easily applied to, for example, a home generation device.

Furthermore, since the buoyancy engine 1 of the embodiment does not generate a pollution material such as an exhaust gas like the internal combustion engine or the external combustion engine of the related art, there is an advantage that the burden on natural environment is small.

While the embodiment of the present invention has been described, the present invention is not limited to the above-described embodiment, and may be modified into various forms.

That is, the shape of the circulation passage or the shape, the size, the number, and the arrangement of the constituent such as the moving body 5, the sealing portion 40, the guide member 30, the rotation bodies 61 and 62, and the rotation body 51 indicated by FIGS. 1 and 2 is merely an example, and may be modified into various forms.

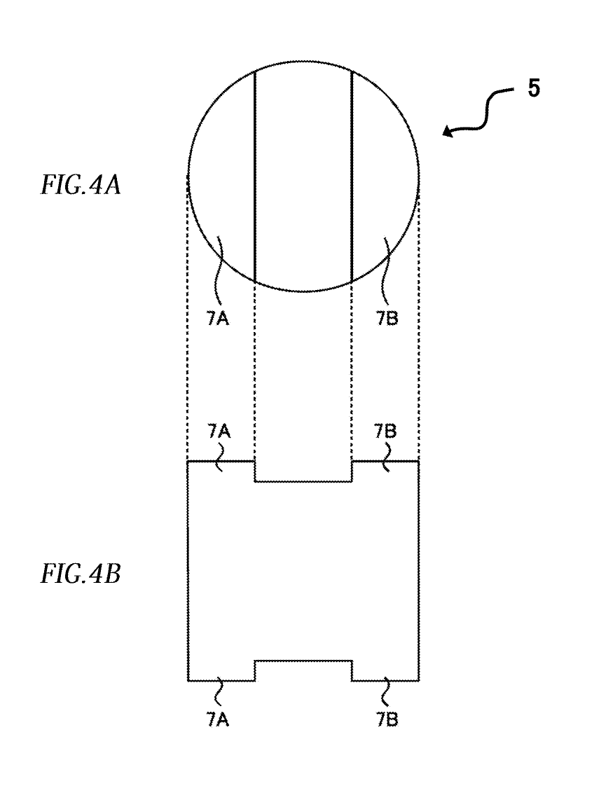

For example, the shape of the convex portion formed in the flat surface portion of the moving body 5 is not limited to the shape illustrated in FIGS. 3A and 3B. In another embodiment of the present invention, for example, as illustrated in FIGS. 4A and 4B, two convex portions 7A and 7B may be formed in the flat surface portion. In the case of the moving body 5 illustrated in FIGS. 4A and 4B, the liquid intrudes into the groove portion formed between the convex portions 7A and 7B, so that buoyancy is generated in the moving body 5, and the raising force is generated by the upward flow of the liquid.

The present invention may be widely applied to a motor that directly uses generated power or a generator that converts power into electricity.

What is claimed is:

1. A buoyancy engine comprising:
a circulation passage forming portion that forms a closed circulation passage including an ascending passage extending in the vertical direction and a return passage returning from an upper end of the ascending passage to a lower end thereof;
a plurality of moving bodies that are arranged in series in the circulation passage;
a liquid injector that injects a liquid having a specific weight heavier than that of each moving body into the ascending passage; and
a sealing portion that seals a gap between an inner wall of the circulation passage forming portion and the moving body located at the lower side of the ascending passage,
wherein the liquid injector includes
a liquid tank that receives the liquid overflowing from the upper end of the ascending passage, and
a pump that sends the liquid flowing out of a lower end of the liquid tank to the lower end of the ascending passage while applying a pressure to the liquid, and
wherein the liquid transported to the lower end of the ascending passage by the pump ascends in the ascending passage, and the moving body is floated in the ascending liquid.

2. The buoyancy engine according to claim 1,
wherein the moving body has a columnar shape in which a convex portion is formed in at least one of two facing flat surfaces, and
wherein when two upper and lower adjacent moving bodies in the ascending passage contact each other, the convex portion or the flat surface of one moving body comes into contact with the convex portion or the flat surface of the other moving body, and a liquid intrusion allowing gap is formed between two moving bodies.

3. The buoyancy engine according to claim 1,
wherein a plurality of stages of sealing portions are provided in the inner wall of the circulation passage forming portion at the lower side of the ascending passage.

4. The buoyancy engine according to claim 1,
wherein the sealing portion includes
an annular groove portion that is formed in the inner wall of the circulation passage forming portion, and
an annular elastic member that is fitted to the groove portion.

5. The buoyancy engine according to claim 1, further comprising:
a guide member that guides the moving body so that the moving body ascends from the lower end of the ascending passage to the upper end thereof in the vertical direction.

6. The buoyancy engine according to claim 1,
wherein the return passage includes
a descending passage that extends in the vertical direction,
a first curved passage that is provided in at least a part of a passage guiding the moving body from the upper end of the ascending passage to the upper end of the descending passage, and
a second curved passage that is provided in at least a part of a passage guiding the moving body from the lower end of the descending passage to the lower end of the ascending passage.

7. The buoyancy engine according to claim 6, further comprising:
at least one rotation body that is provided in the inner wall of the circulation passage forming portion forming the first curved passage and/or the second curved passage and rotates while contacting the moving body.

8. The buoyancy engine according to claim 1, further comprising:
a rotation body; and
a generator that generates electric power in response to the rotation about the axis of the rotation body,
wherein the rotation body rotates while contacting the moving body exposed to the outside through a notched hole formed in a part of the circulation passage forming portion forming the return passage.
